(19) United States
(12) Patent Application Publication
(10) Pub. No.: US 2008/0068827 A1
(43) Pub. Date: Mar. 20, 2008

(54) Hand tool with an illumination device

(76) Inventor: Ming-Chi Chang, Taichung City (TW)

Correspondence Address: MING-CHI CHANG, 235 Chung - Ho, Box 8-24, Taipei, omitted

(21) Appl. No.: 11/523,822

(22) Filed: Sep. 19, 2006

(51) Int. Cl. B25B 23/18

(52) U.S. Cl. 362/119

(57) ABSTRACT

A hand tool with an illumination device comprises a handle; a driving head extending from one end of the handle; an illumination device; a switch for controlling the actuation of the illumination device; an optical fiber tube being connected to the illumination device for transferring light from the illumination device to an illumination point. The optical fiber tube is enclosed by an outer cover which is bendable so as to adjust an orientation of the optical fiber tube. A free end of the optical fiber tube has a light collecting head for collecting light. The hand tool is a spanner or a screwdriver. The illumination device and the switch are installed on the handle near the driving head.

### FIELD OF THE INVENTION

The present invention relates to hand tools, a hand tool with an illumination device, wherein the illumination point from the illumination device is adjustable and the light from the illumination device can be collected so as to be projected out to the illumination point effectively.

### BACKGROUND OF THE INVENTION

When a hand tool is used to a dark area, it is often that the hand tool can not align to a screwing object so that the user must try several times for aligning the hand tool to the screw object. This is time consumed and inefficient. Furthermore, some mistakes will occur or the operator will be hurt.

Some hand tools are installed with illumination devices for improving above mentioned defects. However these improved designs has the following defects. The illumination point can not changed to the screw unit to be driven and thus the light from the light source can not project a desired illumination point. The light emitted from the light emitting diodes is radiated out so as to reduce the intensity of the light when the light is transferred to the illumination point. Thus the object to be driven cannot be identified clearly.

### SUMMARY OF THE INVENTION

Accordingly, the primary object of the present invention is to provide a hand tool with an illumination device, wherein the illumination point from the illumination device is adjustable and the light from the illumination device can be collected so as to be projected out to the illumination point effectively.

To achieve above objects, the present invention provides a hand tool with an illumination device which comprises a handle; a driving head extending from one end of the handle; an illumination device; a switch for controlling the actuation of the illumination device; an optical fiber tube being connected to the illumination device for transferring light from the illumination device to an illumination point. The optical fiber tube is enclosed by an outer cover which is bendable so as to adjust an orientation of the optical fiber tube. A free end of the optical fiber tube has a light collecting head for collecting light. The hand tool is a spanner or a screw driver. The illumination device and the switch are installed on the handle near the driving head.

The various objects and advantages of the present invention will be more readily understood from the following detailed description when read in conjunction with the appended drawing.

### BRIEF DESCRIPTION OF THE DRAWINGS

FIG. 1 is a lateral schematic view about the hand tool with an illumination device of the present invention.

FIGS. 2 to 4 are schematic views showing the bending of the outer cover of the hand tool with an illumination device of the present invention.

FIG. 5 is a schematic view showing the operation of the hand tool with an illumination device of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

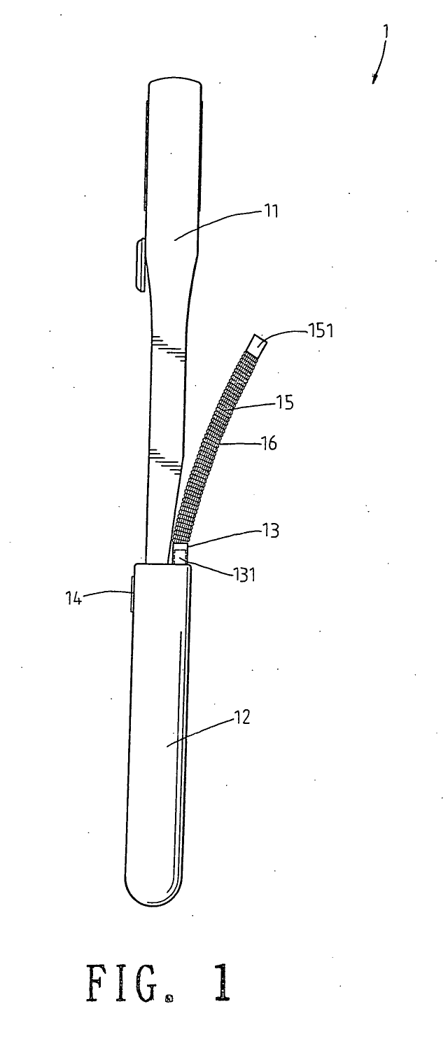

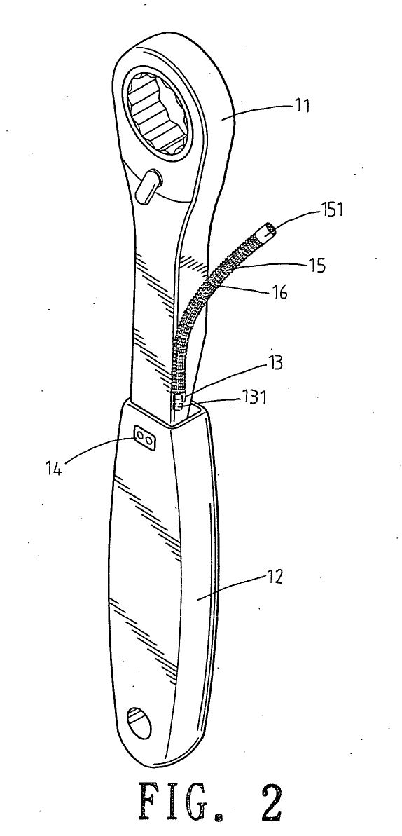

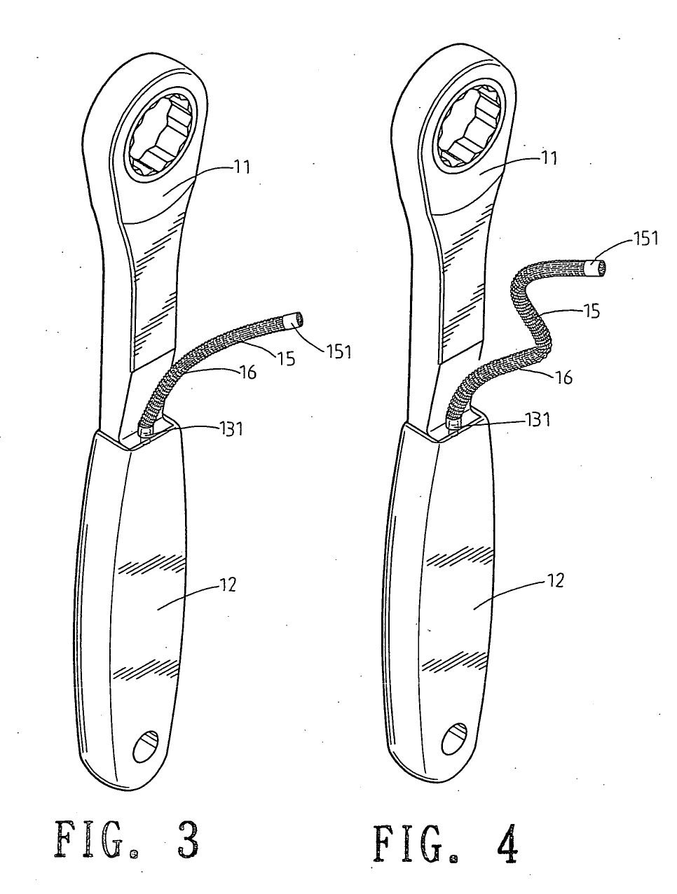

Referring to FIGS. 1 to 3, the illumination device of a hand tool of the present invention is illustrated. The present invention has the following elements.

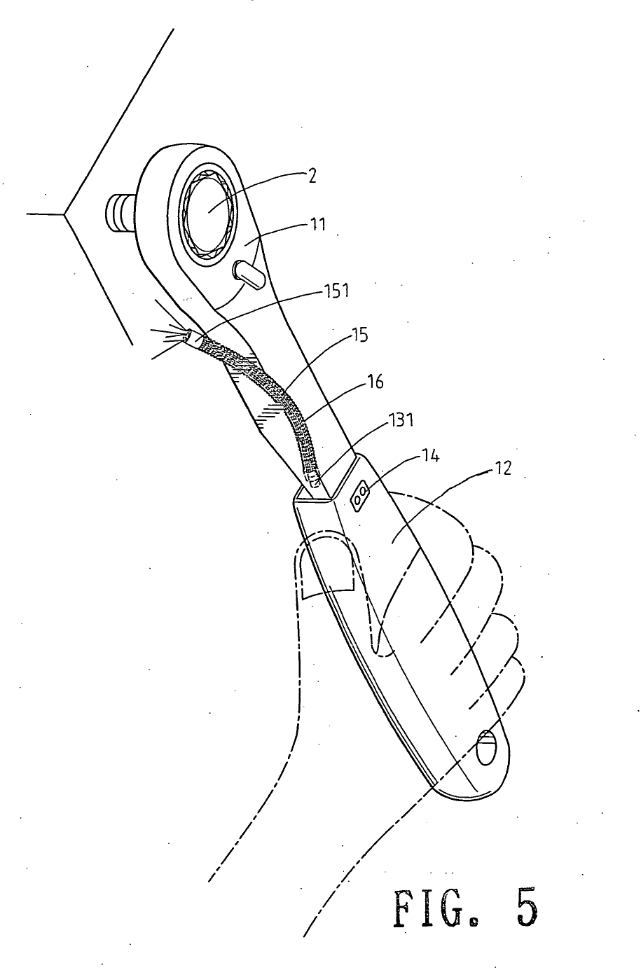

A body 1 may be a spanner or a screw driver. The body 1 mainly includes a driving head 11 and a handle 12. The driving head 11 is installed at one end of the body 1 for driving a screw means (referring to FIG. 5). Another end of the body 1 has the handle 12. An illumination device 13 and a switch 14 are installed at a connection of the handle 12 and the driving head 11.

A light source of the illumination device 13 is light emitting diodes 131. An optical fiber tube 15 is installed to the light emitting diodes 131 for guiding the light from the light emitting diodes 131. The light from the light emitting diodes 131 is collected at a light collecting head 151 for emitting out and projecting to an illumination point of a screw unit 2. An outer side of the optical fiber tube 15 is covered by an outer cover 16. The outer cover 16 is bendable for being positioned. By the outer cover 16, the orientation of the optical fiber tube 15 can be adjusted as desired so that light can be projected to an illumination point.

The switch 14 serves for switching the illumination device 13. When the switch 14 is actuated, the illumination device 13 is actuated. When the switch 14 is closed, the illumination device 13 is not used.

In use of the present invention, referring to FIG. 4, when the working environment is dark, the switch 14 is actuated so as to actuate the illumination device 13. Light is emitted from the light emitting diodes 131. The light transmits through the optical fiber tube 15. The moving the outer cover 16, a free end of the optical fiber tube 15 can point to an illumination point and is positioned. When the hand tool is used, the free end of the optical fiber tube 15 and the body 1 move around the screw unit 2. Thus during operation, it is unnecessary to adjust the projection direction of the light source. If the illumination is unnecessary, the switch 14 is closed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hand tool with an illumination device comprising:
a handle;
a driving head extending from one end of the handle;
an illumination device;
a switch for controlling the actuation of the illumination device;
an optical fiber tube being connected to the illumination device for transferring light from the illumination device to an illumination point.

2. The hand tool with an illumination device as claimed in claim 1, wherein the optical fiber tube is enclosed by an outer cover which is bendable so as to adjust an orientation of the optical fiber tube.

3. The hand tool with an illumination device as claimed in claim 1, wherein a free end of the optical fiber tube has a light collecting head for collecting light.

4. The hand tool with an illumination device as claimed in claim 1, wherein the hand tool is a spanner or a screw driver.

5. The hand tool with an illumination device as claimed in claim 1, wherein the illumination device and the switch are installed on the handle near the driving head.
